(19) United States
(12) Patent Application Publication
(10) Pub. No.: US 2026/0342463 A1
(43) Pub. Date: Oct. 29, 2026

(54) RADIO WAVE ABNORMALITY DETECTION SYSTEM, RADIO WAVE ABNORMALITY DETECTION METHOD, AND NON-TRANSITORY COMPUTER READABLE MEDIUM

(71) Applicant: NEC Corporation, Tokyo (JP)

(72) Inventor: Toshiki TAKEUCHI, Tokyo (JP)

(73) Assignee: NEC Corporation, Tokyo (JP)

(21) Appl. No.: 19/644,108

(22) Filed: Apr. 10, 2026

(30) Foreign Application Priority Data
Apr. 23, 2025 (JP) 2025-071410

(51) Int. Cl. H04B 17/391; G06F 18/213

(52) U.S. Cl. CPC H04B 17/3913; G06F 18/213

(57) ABSTRACT

Provided is a radio wave abnormality detection system including a learning unit that learns a radio wave environment in a normal state, the learning unit including a feature value learning unit that extracts and learns one or more feature values, and a normality information calculation unit that calculates normality information based on information of a feature value distribution of a learning result, the normality information calculation unit including a signal distribution division unit that divides a distribution of a signal-present portion and a distribution of a signal-absent portion, a signal-present distribution normality value calculation unit that calculates a normality value of the distribution of the signal-present portion, and a signal-absent distribution normality value setting unit that sets the normality value of the distribution of the signal-absent portion.

### INCORPORATION BY REFERENCE

This application is based upon and claims the benefit of priority from Japanese patent application No. 2025-71410, filed on Apr. 23, 2025, the disclosure of which is incorporated herein in its entirety by reference.

### TECHNICAL FIELD

The present disclosure relates to a radio wave abnormality detection system, a radio wave abnormality detection method, and a program. In particular, the present disclosure relates to improvement of an index indicating how much the surrounding radio wave environment at the time of interference detection is similar to the normal radio wave environment.

### BACKGROUND ART

There is known a detection method for learning a radio wave environment in a normal state and detecting a radio wave environment deviating from the radio wave environment as an abnormality during operation. JP 2023-141473 A discloses a radio wave abnormality detection system capable of accurately detecting a radio wave abnormality.

### SUMMARY

However, only by visualizing the inference result such as the extraction value/inference value or the determination result of normality/abnormality for each feature value at the time of operation, it is not possible to determine whether it is an average state at the normal time or a state of a boundary that becomes abnormal. Therefore, an example object of the present disclosure is to provide a radio wave abnormality detection system or the like that calculates an index relevant to a normality at the time of learning, and performs normality/abnormality determination and visualization using the index relevant to the normality at the time of operation that is at the time of inference.

A radio wave abnormality detection system according to an example aspect of the present disclosure includes
a learning unit that learns a radio wave environment in a normal state, the learning unit including
a feature value learning unit that extracts and learns one or more feature values, and
a normality information calculation unit that calculates normality information based on information of a feature value distribution of a learning result, the normality information calculation unit including a signal distribution division unit that divides a distribution of a signal-present portion and a distribution of a signal-absent portion, a signal-present distribution normality value calculation unit that calculates a normality value of the distribution of the signal-present portion, and a signal-absent distribution normality value setting unit that sets the normality value of the distribution of the signal-absent portion.

A radio wave abnormality detection method according to an example aspect of the present disclosure includes
extracting and learning one or more feature values,
dividing a distribution of a signal-present portion and a distribution of a signal-absent portion, calculating a normality value of the distribution of the signal-present portion, and setting the normality value of the distribution of the signal-absent portion so as to calculate normality information based on information of a feature value distribution of a learning result, and
learning a radio wave environment in a normal state.

A program according to an example aspect of the present disclosure causes an information processing device to execute
extracting and learning one or more feature values,
dividing a distribution of a signal-present portion and a distribution of a signal-absent portion, calculating a normality value of the distribution of the signal-present portion, and setting the normality value of the distribution of the signal-absent portion so as to calculate normality information based on information of a feature value distribution of a learning result, and
learning a radio wave environment in a normal state.

A radio wave abnormality detection system according to an example aspect of the present disclosure includes
a visualization unit that receives normality information and a normality/abnormality determination result of a surrounding radio wave environment, and visualizes the normality information and the normality/abnormality determination result with which a signal-present portion and a signal-absent portion can be distinguished from an input value.

According to an example advantage of the present disclosure, there is provided a radio wave abnormality detection system that also calculates an index relevant to a normality at the time of learning, and performs normality/abnormality determination and visualization using the index relevant to the normality at the time of operation that is at the time of inference.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of normality/abnormality determination by an OC-SVM;

FIG. 2 is a diagram illustrating an example of a normality index according to a related technology;

FIG. 3 is a diagram illustrating an example of a signal intensity distribution according to the present disclosure;

FIG. 4 is a diagram illustrating an example of calculation of a normality value according to the present disclosure;

FIG. 5 is a block diagram illustrating a configuration of a radio wave abnormality detection system according to the present disclosure;

FIG. 6 is a flowchart of learning of a radio wave abnormality detection method according to the present disclosure;

FIG. 7 is a flowchart of determination of a radio wave abnormality detection method according to the present disclosure;

FIG. 8 is a diagram illustrating an example in which an extraction result and a determination result for each feature value are visualized according to the present disclosure;

FIG. 9 is a diagram illustrating an example in which normality and a determination result for each feature value are visualized according to the present disclosure;

FIG. 10 is a diagram illustrating Example 1 of a distribution and a normality value at the time of normal signal learning according to the present disclosure;

FIG. 11 is a diagram illustrating Example 2 of the distribution and the normality value at the time of normal signal learning according to the present disclosure;

FIG. 12 is a diagram illustrating Example 3 of the distribution and the normality value at the time of normal signal learning according to the present disclosure;

FIG. 13 is a block diagram illustrating a second configuration of the learning unit of the radio wave abnormality detection system according to the present disclosure;

FIG. 14 is a block diagram illustrating a second configuration of the determination unit of the radio wave abnormality detection system according to the present disclosure;

FIG. 15 is a block diagram illustrating a third configuration of the radio wave abnormality detection system according to the present disclosure;

FIG. 16 is a block diagram illustrating a fourth configuration of the radio wave abnormality detection system according to the present disclosure; and

FIG. 17 is a block diagram illustrating a configuration of an information processing device according to the present disclosure.

### EXAMPLE EMBODIMENTS

### Description of Radio Wave Normality/Abnormality Determination According to Related Art

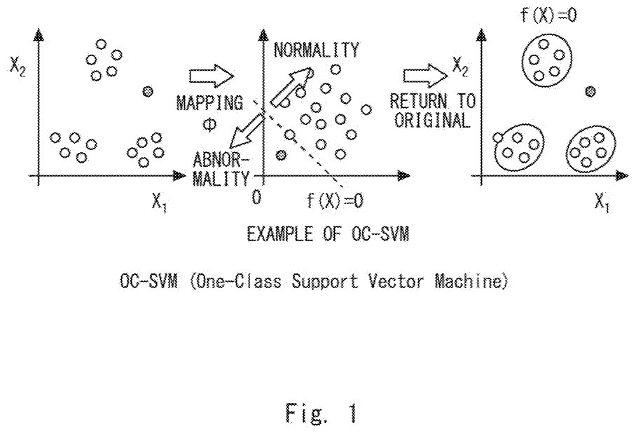

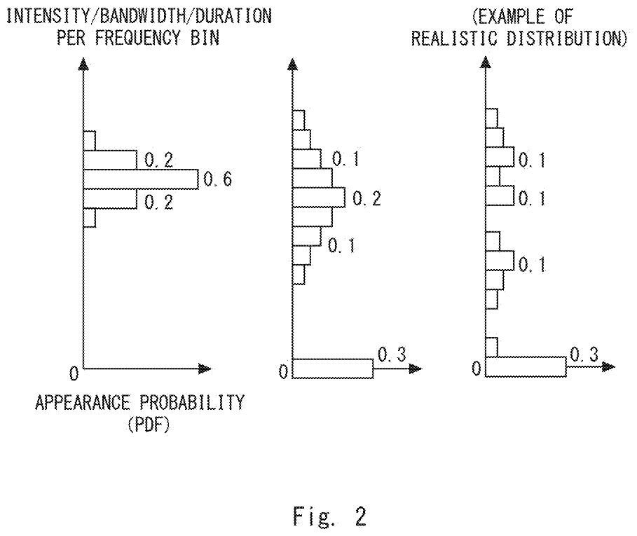

FIG. 1 is a diagram illustrating an example of normality/abnormality determination by an OC-SVM. FIG. 2 is a diagram illustrating an example of a normality index according to the related art. The normality/abnormality determination according to the related art will be described with reference to FIGS. 1 and 2.

In the first related art, as illustrated in FIG. 1, in a One-Class Support Vector Machine (OC-SVM), mapping of raw data is taken to draw a boundary line, normality and abnormality are distinguished, and the mapping is returned to the original state. In the first related art, the feature value such as the intensity/duration/bandwidth for each frequency is used as an input, and the index relevant to the normality/abnormality of the learning model output of the OC-SVM is used as it is. In this method, an index relevant to the normality is obtained for each frequency bin. However, the value of the normality/abnormality is a black box, and it is difficult to associate how much the radio wave environment resembles the normal radio wave environment from the absolute value. It is also difficult to distinguish the presence or absence of the normal signal from the value of the normality/abnormality.

In the second related art, as illustrated in FIG. 2, the distribution at the normal time is normalized for each frequency and used as the determination index, and the distribution that is the appearance probability as the learning result at the normal time is used as the index relevant to the normality as it is. In this method, the appearance probability/frequency of the normal state is reflected in the determination index. However, even the same numerical value such as 0.2 has a different meaning and is not intuitive. It is difficult to analogize from the index value whether it is close to the normal state or the boundary. It is also difficult to distinguish from a case where there is no normal signal.

### Description of Object of Present Disclosure

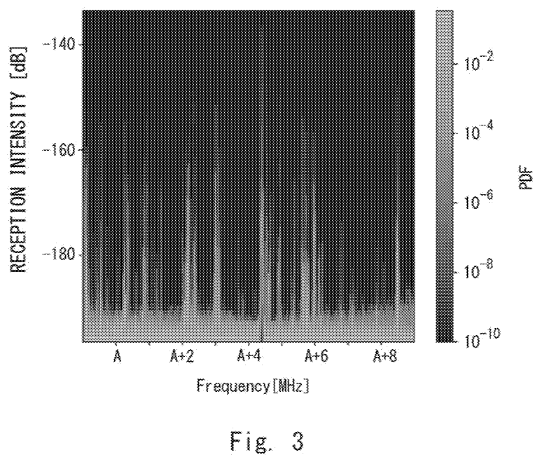

FIG. 3 is a diagram illustrating an example of a signal intensity distribution according to the present disclosure. An object of the present disclosure is to derive normality as a determination index from a signal intensity distribution as illustrated in FIG. 3. The presence or absence of the signal can be estimated from the determination index, the position in the distribution in the normal state can be estimated from the determination index, and the normality/abnormality determination can be performed using the determination index.

### Description of Outline of Present Disclosure

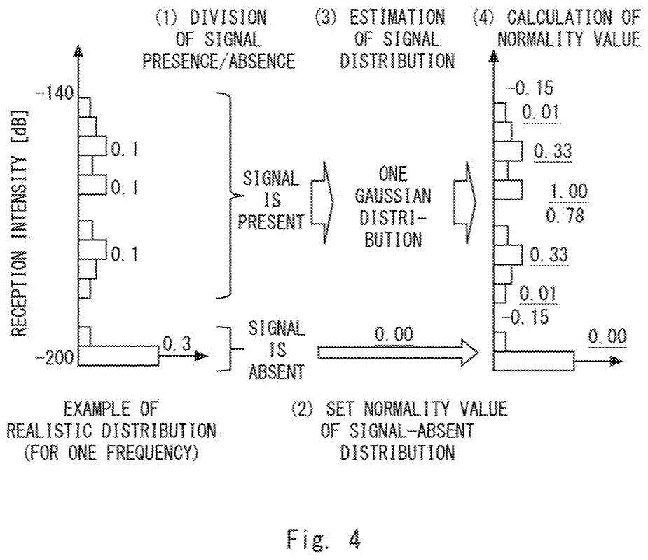

In the present disclosure, the distribution of the learning result is assumed to be a combination of one or more distributions, and the value of the normality which is the normality/abnormality is calculated based on the frequency distribution. FIG. 4 is a diagram illustrating an example of calculation of a normality value according to the present disclosure. As illustrated in FIG. 4, first, the distribution of the signal-present portion and the distribution of the signal-absent portion, which is the noise portion, are divided from the distribution for a plurality of frequencies (1). Next, with respect to the distribution of the signal-absent portion, a fixed value that is known is set (2). Next, the distribution of the signal-present portion is divided into one or a plurality of distributions for each frequency, and a precondition distribution such as a Gaussian distribution is determined for each divided distribution (3). Then, for each of the divided distributions, a normality value is calculated based on the value of the acquired frequency distribution according to the precondition distribution (4). At the time of inference, normality/abnormality is determined with reference to a normality value relevant to an inference result.

### Description of Radio Wave Abnormality Detection System According to First Example Embodiment

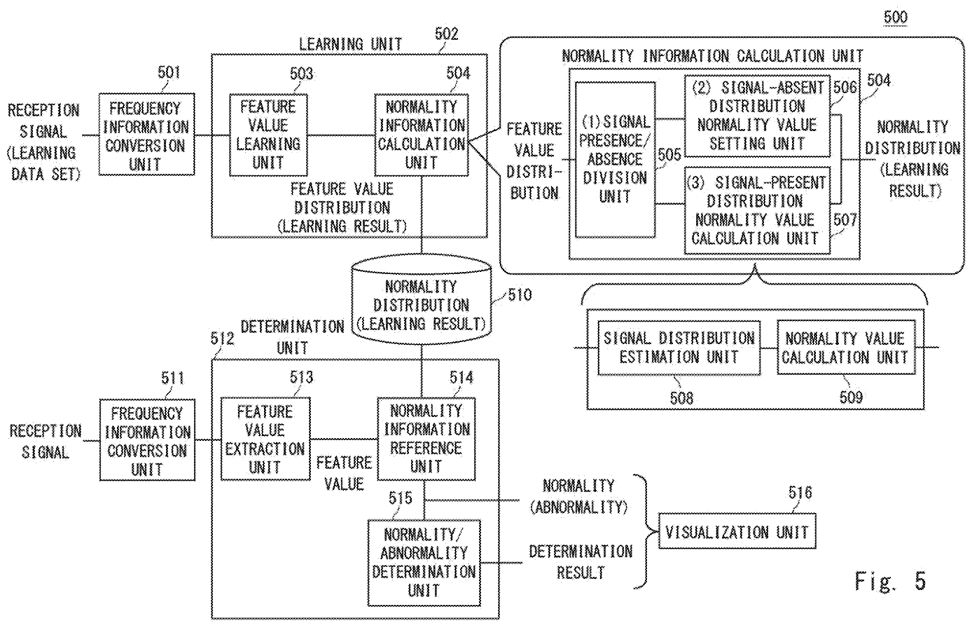

FIG. 5 is a block diagram illustrating a configuration of a radio wave abnormality detection system according to the present disclosure. A radio wave abnormality detection system according to the first example embodiment will be described with reference to FIG. 5.

As illustrated in FIG. 5, a radio wave abnormality detection system 500 includes a frequency information conversion unit 501, a learning unit 502, a normality distribution 510, a frequency information conversion unit 511, a determination unit 512, and a visualization unit 516.

The frequency information conversion unit 501 receives a reception signal as a learning data set and converts the reception signal into signal data including frequency information such as a spectrum or a spectrogram for each time. The reception signal is set in a frequency range in which an abnormality is desired to be detected. A radio wave in a normal state is input to the reception signal.

The learning unit 502 includes a feature value learning unit 503 and a normality information calculation unit 504. The feature value learning unit 503 extracts feature values for each frequency such as signal power, signal duration, and signal bandwidth from signal data including frequency information, and learns feature values such as signal power, signal duration, signal bandwidth, signal duration bandwidth, normality/abnormality, and similarity. The feature value learning unit 503 outputs a feature value distribution as a learning result.

The normality information calculation unit 504 includes a signal presence/absence division unit 505, a signal-absent distribution normality value setting unit 506, and a signal-present distribution normality value calculation unit 507. The signal presence/absence division unit 505 divides the distribution of the signal-present portion and the distribution of the signal-absent portion, which is the noise portion, from the distribution for a plurality of frequencies.

The signal-absent distribution normality value setting unit 506 sets a fixed value that indicates the distribution of the signal-absent portion. The signal-present distribution normality value calculation unit 507 divides the distribution of the signal-present portion into one or a plurality of distributions for each frequency, and determines a precondition distribution such as a Gaussian distribution for each of the divided distributions. Then, the signal-present distribution normality value calculation unit 507 calculates a normality value based on the value of the acquired frequency distribution according to the precondition distribution for each of the divided distributions. The signal-absent distribution normality value setting unit 506 and the signal-present distribution normality value calculation unit 507 can also be referred to as a signal distribution estimation unit 508 and a normality value calculation unit 509.

The normality distribution 510 is a learning result of the learning unit 502.

The frequency information conversion unit 511 receives an actual reception signal and converts the reception signal into signal data including frequency information such as a spectrum or a spectrogram for each time.

The determination unit 512 includes a feature value extraction unit 513, a normality information reference unit 514, and a normality/abnormality determination unit 515. The feature value extraction unit 513 extracts a feature value of data such as signal power, signal duration, signal bandwidth, signal duration bandwidth, normality/abnormality, and similarity from signal data including frequency information. The normality information reference unit 514 refers to the normality distribution 510 to acquire normality or abnormality. The normality/abnormality determination unit 515 outputs a determination result of normality or abnormality.

The visualization unit 516 displays the extraction result of the feature value and the normality/abnormality degree or the normality/abnormality determination result. The visualization unit 516 performs display using a user interface such as a display.

### Description of Radio Wave Abnormality Detection Method According to First Example Embodiment

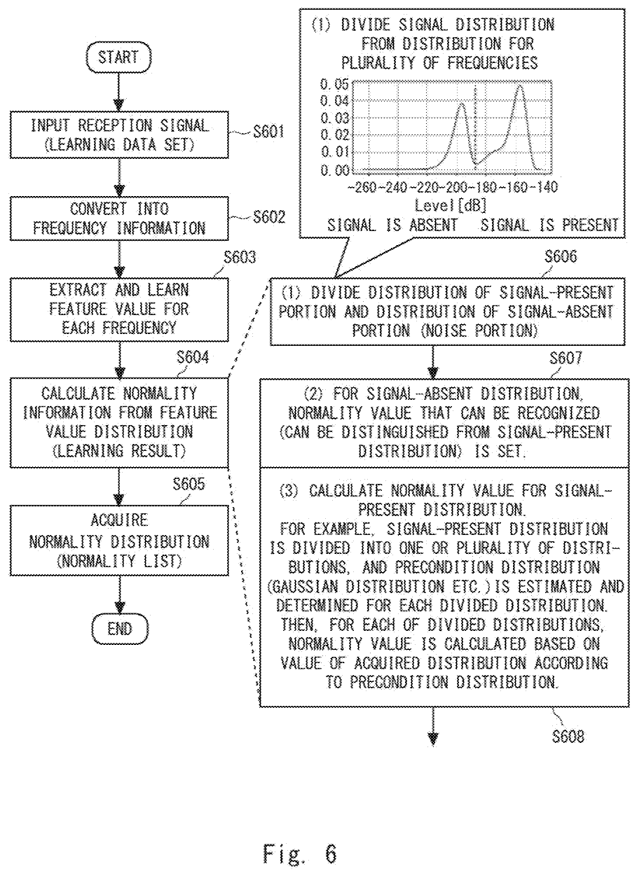

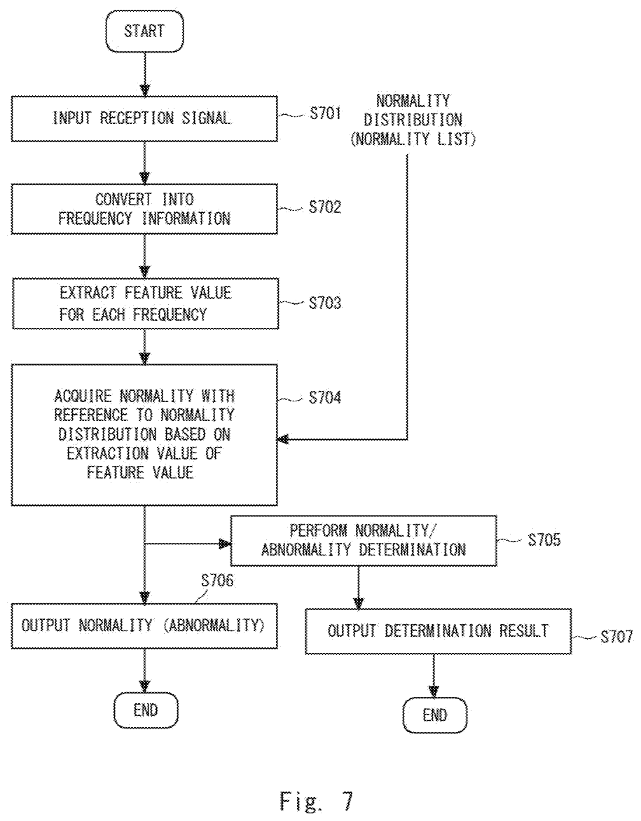

FIG. 6 is a flowchart of learning of the radio wave abnormality detection method according to the present disclosure. FIG. 7 is a flowchart of determination of a radio wave abnormality detection method according to the present disclosure. The radio wave abnormality detection method according to the first example embodiment will be described with reference to FIGS. 6 and 7.

As illustrated in FIG. 6, in the learning, first, a reception signal that is a learning data set is input (step S601). Next, the reception signal is converted into frequency information (S602). Next, a feature value is extracted and learned for each frequency (step S603).

Next, normality information is calculated from the feature value distribution that is a learning result (step S604). Step S604 includes steps S606, S607, and S608. First, the distribution of the signal-present portion and the distribution of the signal-absent portion, which is the noise portion, are divided (step S606). Step S606 includes dividing a signal distribution from a distribution for a plurality of frequencies. Next, a normality value that can be distinguished from the signal-present distribution is set for the signal-absent distribution (step S607). Then, a normality value is calculated for the signal-present distribution (step S608). For example, the signal-present distribution is divided into one or a plurality of distributions, and a precondition distribution such as a Gaussian distribution is estimated and determined for each divided distribution. Then, for each of the divided distributions, the normality value is calculated based on the value of the acquired distribution according to the precondition distribution.

After step S604, the normality distribution as the normality list is acquired (step S605), and the learning flow of the radio wave abnormality detection method is ended.

As illustrated in FIG. 7, in the determination, first, a reception signal is input (step S701). Next, conversion into frequency information is performed (step S702). Next, a feature value is extracted for each frequency (step S703). Next, the normality is acquired with reference to the normality distribution based on the extraction value of the feature value. (Step S704). The normality/abnormality is output (step S706). Normality/abnormality determination is performed from the result of step S704 (step S705). The determination result is output (step S707).

The above configuration is a determination flow of the radio wave abnormality detection method. With the above configuration, there is provided a radio wave abnormality detection method for calculating an index relevant to the normality at the time of learning, and performing normality/abnormality determination and visualization using the index relevant to the normality at the time of operation that is at the time of inference.

### Description of Visualization Unit According to Example Embodiment

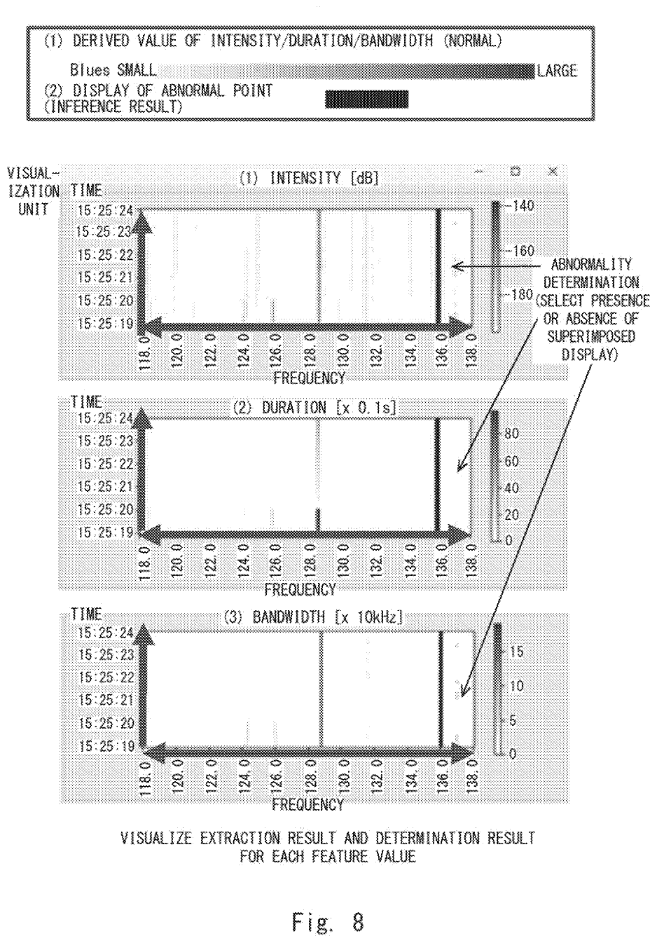

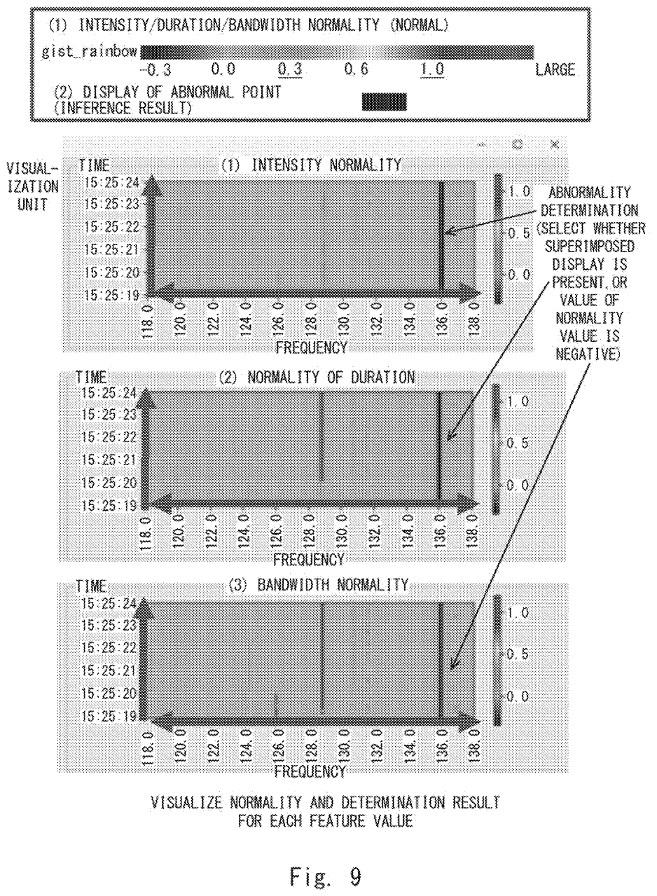

FIG. 8 is a diagram illustrating an example in which an extraction result and a determination result for each feature value are visualized according to the present disclosure. FIG. 9 is a diagram illustrating an example in which normality and a determination result for each feature value are visualized according to the present disclosure. The visualization unit according to the example embodiment will be described with reference to FIGS. 8 and 9.

As illustrated in FIG. 8, the extraction result and the normality/abnormality determination result for each feature value of the intensity, the duration, and the bandwidth are displayed. In a case where the extraction result of the feature value is displayed as illustrated in FIG. 8, the feature value from the feature value extraction unit 513 is output to the visualization unit 516 in FIG. 5 although not illustrated. Therefore, the presence or absence of a signal can be intuitively grasped for each frequency. As illustrated in FIG. 9, the normality and the determination result for each feature value are visualized. Therefore, it is possible to intuitively grasp the position in the distribution of the normal state, the average state at the normal time, the state of the boundary that becomes abnormal, and the like. The table of FIG. 8 and the table of FIG. 9 are switched and displayed. That is, the visualization unit 516 can switch between the extraction result of the feature value and the normality information and select whether to display the normality/abnormality determination result in a superimposed manner.

The normality value can be used to determine normality/abnormality and detect an interference signal.

### Description of Normality Value According to Example Embodiment

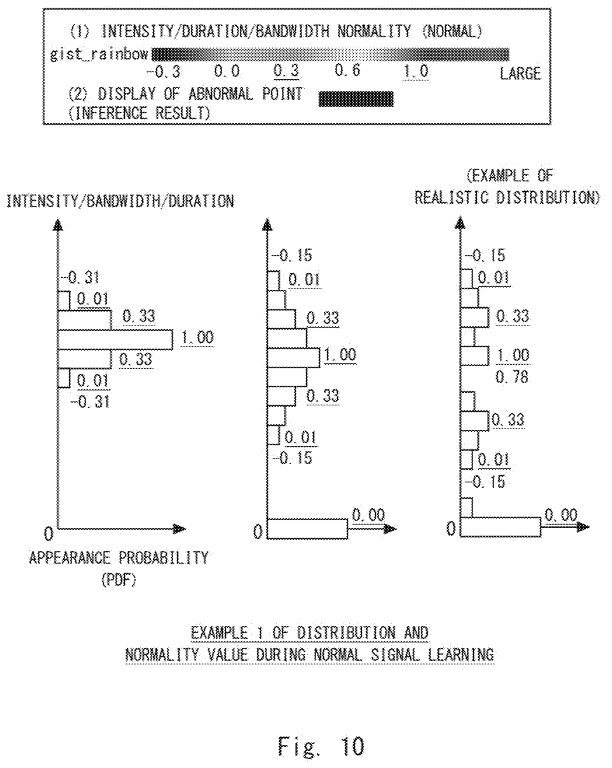

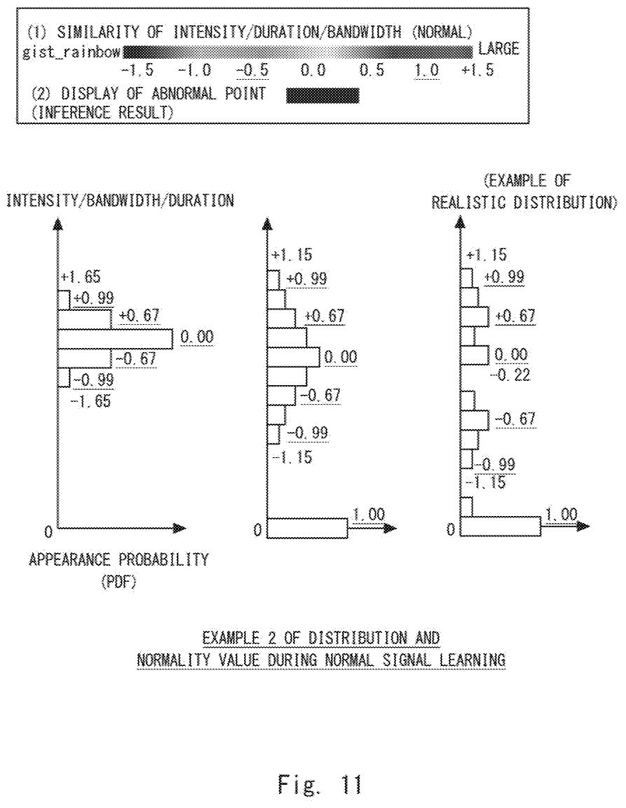

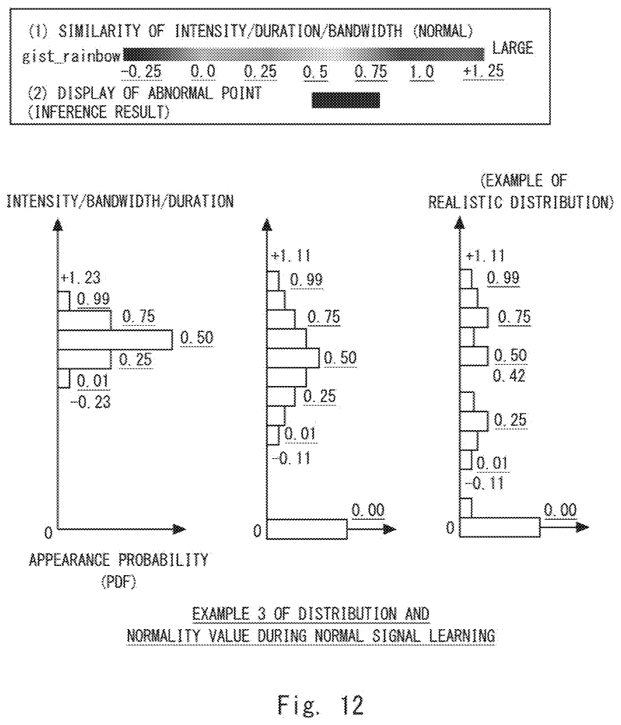

FIG. 10 is a diagram illustrating Example 1 of the distribution and the normality value at the time of normal signal learning according to the present disclosure. FIG. 11 is a diagram illustrating Example 2 of the distribution and the normality value at the time of normal signal learning according to the present disclosure. FIG. 12 is a diagram illustrating Example 3 of the distribution and the normality value at the time of normal signal learning according to the present disclosure. A normality value according to an example embodiment will be described with reference to FIGS. 10 to 12.

As illustrated in FIG. 10, the normality value which is an index relevant to the normality and from which the position in the distribution in the normal state can be analogized is allocated as follows. First, as illustrated in the middle diagram and the right diagram in FIG. 10, assuming that the distribution of the learning result is two types of Gaussian distributions of the signal-present distribution and the signal-absent distribution, the normality value, which is the normality/abnormality, is calculated based on the frequency distribution. Specifically, the frequency distribution of the learning result is divided into the signal-present distribution and the signal-absent distribution. The left diagram in FIG. 10 is a case where one ideal Gaussian distribution is assumed. The Gaussian distribution may be a normal distribution. As illustrated in all the entire drawing of FIG. 10, the bin of the average value or the median value is assumed to be 1.00. The bin including the 33% signal-present value and the 67% signal-present value is set to 0.33. The bin of the minimum value and the maximum value of the signal-present value is set to 0.01. The remaining bins are linearly approximated to be provisional values that are not 0. The signal-absent bin is overwritten with 0 or a specific fixed value. At the time of inference, the normality value of the bin is displayed, and normality/abnormality is also determined by a symbol of +/− of the normality. PDF in FIG. 10 means a probability density function.

As illustrated in FIG. 11, the normality value which is an index relevant to the normality/abnormality and from which the position in the distribution in the normal state can be analogized is allocated as follows. First, as illustrated in the middle diagram and the right diagram in FIG. 11, assuming that the distribution of the learning result is two types of Gaussian distributions of the signal-present distribution and the signal-absent distribution, the normality value, which is the normality/abnormality, is calculated based on the frequency distribution. Specifically, the frequency distribution of the learning result is divided into the signal-present distribution and the signal-absent distribution. The left diagram in FIG. 11 is a case where one ideal Gaussian distribution is assumed. The Gaussian distribution may be a normal distribution. As illustrated in all the entire drawing of FIG. 11, the bin of the average value or the median value is assumed to be 0.00. The bin including the 33% signal-present value and the 67% signal-present value is set to +/−0.67. The bin of the minimum value and the maximum value of the signal-present value is set to +/−0.99. The remaining bins are linearly approximated to be provisional values that are not 1.00. The signal-absent bin is overwritten with +1.00 or a specific fixed value. At the time of inference, the normality value of the bin is displayed, and normality/abnormality is also determined by an absolute value of the normality, such as whether the absolute value of the normality is within 1.00 or exceeds 1.00.

As illustrated in FIG. 12, the normality value which is an index relevant to the normality and from which the position in the distribution in the normal state can be analogized is allocated as follows. First, as illustrated in the middle diagram and the right diagram in FIG. 12, assuming that the distribution of the learning result is two types of Gaussian distributions of the signal-present distribution and the signal-absent distribution, the normality value, which is the normality/abnormality, is calculated based on the frequency distribution. Specifically, the frequency distribution of the learning result is divided into the signal-present distribution and the signal-absent distribution. The left diagram in FIG. 12 is a case where one ideal Gaussian distribution is assumed. The Gaussian distribution may be a normal distribution. As illustrated in the entire diagram of FIG. 12, the bin of the median value is assumed to be 0.5 using the value of the CDF (Cumulative Distribution Function) with signal. The bins including the 25% value and the 75% value are defined as 0.25 and 0.75. For example, the bins of the minimum value and the maximum value are 0.01 and 0.99. The remaining bins also calculate normality values based on the CDF values, and the bins outside the range are extrapolated and supplemented with values other than 0.00 and 1.00. The signal-absent bin is overwritten with 0.00, 1.00, or a specific fixed value. At the time of inference, the normality value of the bin is displayed, and normality/abnormality is also determined by normality range determination such as a value of 0 or more and 1 or less, or a value in other ranges.

### Description of Radio Wave Abnormality Detection Device According to Second Example Embodiment

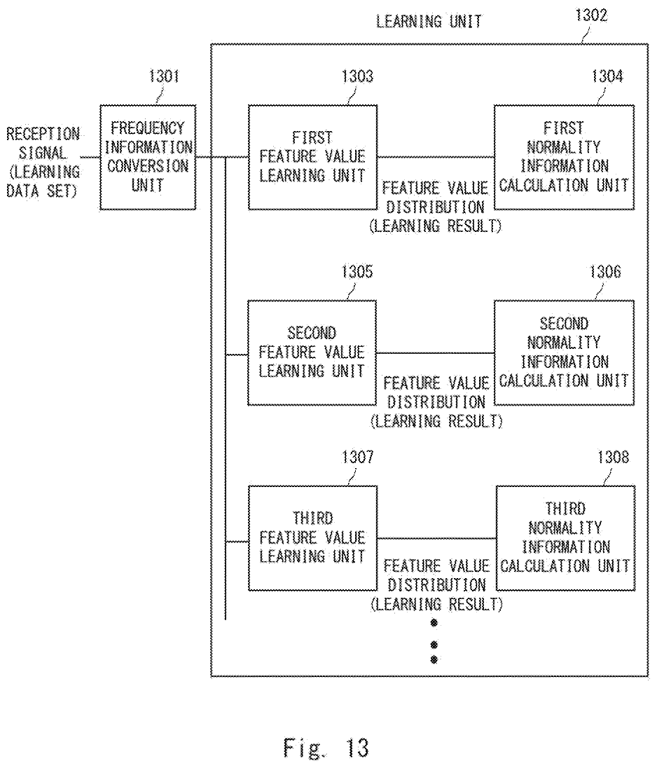

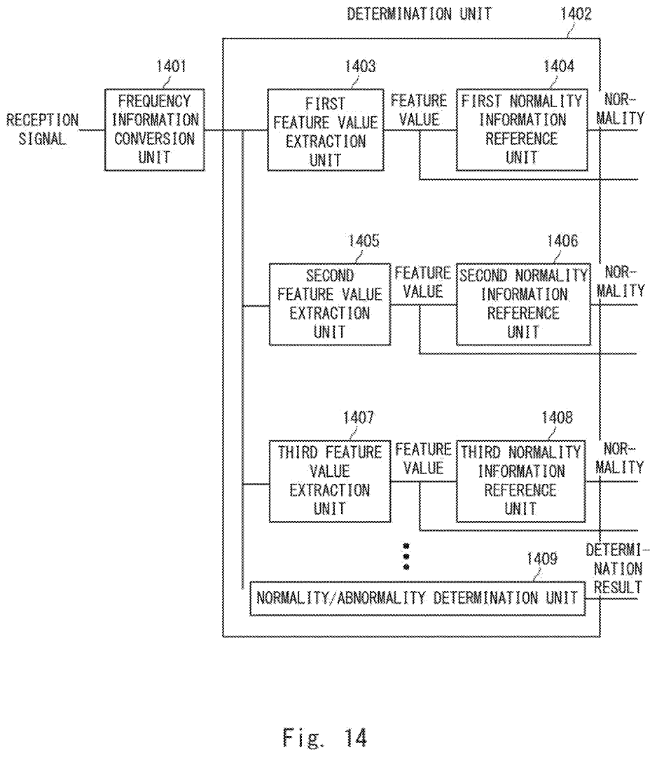

FIG. 13 is a block diagram illustrating a second configuration of the learning unit of the radio wave abnormality detection system according to the present disclosure. FIG. 14 is a block diagram illustrating a second configuration of the determination unit of the radio wave abnormality detection system according to the present disclosure. A radio wave abnormality detection system according to the second example embodiment will be described with reference to FIGS. 13 and 14.

As illustrated in FIG. 13, a learning unit 1302 of the radio wave abnormality detection system according to the second example embodiment is different from the learning unit 502 of the radio wave abnormality detection system 500 according to the first example embodiment in that it includes a plurality of feature value learning units and a plurality of normality information calculation units. As illustrated in FIG. 14, a determination unit 1402 of the radio wave abnormality detection system according to the second example embodiment is different from the determination unit 512 of the radio wave abnormality detection system 500 according to the first example embodiment in that the determination unit includes a plurality of feature value extraction units and a plurality of normality information reference units.

As illustrated in FIG. 13, the learning unit 1302 of the radio wave abnormality detection system according to the second example embodiment includes a first feature value learning unit 1303, a first normality information calculation unit 1304, a second feature value learning unit 1305, a second normality information calculation unit 1306, a third feature value learning unit 1307, and a third normality information calculation unit 1308. The learning unit 1302 may further include a set of a feature value learning unit and a normality information calculation unit.

The reception signal input from a frequency information conversion unit 1301 is decomposed into a plurality of feature values. From the reception signal, for example, a plurality of feature values such as signal power, signal duration, and signal bandwidth are extracted and learned. The result learned by the first feature value learning unit 1303 is used by the first normality information calculation unit 1304 as a feature value distribution. The first normality information calculation unit 1304 calculates first normality information. It is possible to grasp the state of the surrounding radio wave environment, or the specifications of the detected interference signal and the information of the normality/abnormality from the extraction values of the plurality of feature values and the normality information thereof.

As illustrated in FIG. 14, the determination unit 1402 of the radio wave abnormality detection system according to the second example embodiment includes a first feature value extraction unit 1403, a first normality information reference unit 1404, a second feature value extraction unit 1405, a second normality information reference unit 1406, a third feature value extraction unit 1407, a third normality information reference unit 1408, and a normality/abnormality determination unit 1409. The determination unit 1402 may further include a set of a feature value extraction unit and a normality information reference unit. The determination unit 1402 includes feature value extraction units and normality information reference units as many as the feature value learning units and the normality information calculation units of the learning unit 1302.

The reception signal input from a frequency conversion unit 1401 is decomposed into a plurality of feature values. From the reception signal, for example, a plurality of feature values such as signal power, signal duration, and signal bandwidth are extracted. The first feature value extraction unit 1403 determines normality/abnormality of the extracted feature value by referring to the normality distribution output by the learning unit 1302 by the first normality information reference unit 1404. The normality/abnormality determination unit 1409 determines normality/abnormality by using the result output from the first normality information reference unit 1404. By outputting the extraction result of the feature value together with the normality information from the determination unit 1402, the visualization unit can switch between visualization of the feature value and visualization of the normality. There is no problem even if the normality/abnormality determination unit 1409 determines normality/abnormality by using the output from the second normality information reference unit 1406 or the third normality information reference unit 1408 other than the first normality information reference unit 1404.

### Description of Radio Wave Abnormality Detection System According to Third Example Embodiment

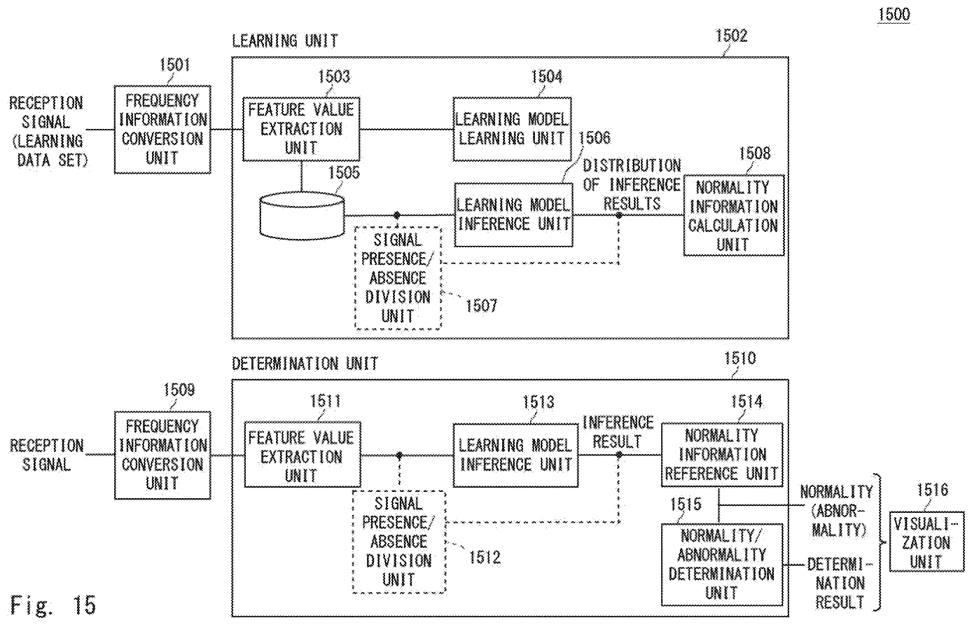

FIG. 15 is a block diagram illustrating a third configuration of the radio wave abnormality detection system according to the present disclosure. A radio wave abnormality detection system according to the third example embodiment will be described with reference to FIG. 15.

As illustrated in FIG. 15, a radio wave abnormality detection system 1500 according to the third example embodiment is different from the radio wave abnormality detection system 500 according to the first example embodiment in that a learning model such as OC-SVM is used.

As illustrated in FIG. 15, the radio wave abnormality detection system 1500 according to the third example embodiment includes a frequency information conversion unit 1501, a learning unit 1502, a frequency information conversion unit 1509, a determination unit 1510, and a visualization unit 1516. The learning unit 1502 includes a feature value extraction unit 1503, a learning model learning unit 1504 such as an OC-SVM, a feature value 1505, a learning model inference unit 1506, a signal presence/absence division unit 1507, and a normality information calculation unit 1508. The determination unit 1510 includes a feature value extraction unit 1511, a signal presence/absence division unit 1512, a learning model inference unit 1513, a normality information reference unit 1514, and a normality/abnormality determination unit 1515.

The reception signal is converted by the frequency information conversion unit 1501. A feature value of the converted signal is extracted by the feature value extraction unit 1503. A learning model such as OC-SVM is learned by the learning model learning unit 1504 using the extracted feature value. The feature value extraction unit extracts the feature value 1505. Before the feature value 1505 passes through the learning model inference unit 1506, the signal presence/absence division unit 1507 determines the presence or absence of a signal and divides the feature value 1505 into two, the presence of a signal and the absence of a signal. The feature value determined to have a signal in the learning data set is passed through the learning model inference unit 1506, and a distribution of inference results is generated. The inferred signal-present distribution and signal-absent distribution are input to the normality information calculation unit, and the normality distribution is calculated.

Similarly, the reception signal is converted by the frequency information conversion unit 1509. A feature value of the converted signal is extracted by the feature value extraction unit 1511. Before passing through the learning model inference unit 1513, the signal presence/absence division unit 1512 determines the presence or absence of a signal and divides the feature value into two, the presence of a signal and the absence of a signal. The feature value determined to have a signal is passed through the learning model inference unit 1513, and an inference result is generated. The inference result of the signal-present data and the information of the signal-absent data are mainly input to the normality information reference unit 1514, and the normality/abnormality is output. The output of the normality information reference unit 1514 is input to the normality/abnormality determination unit 1515, and normality/abnormality is determined.

The visualization unit 1516 displays the normality/abnormality and the determination result of normality/abnormality. With the above configuration, the normality information can be calculated using the learning model such as the OC-SVM. Even if the information of the normality/abnormality output by the learning model is the black box, it is possible to intuitively grasp the information of the normality/abnormality in the surrounding radio wave environment at the time of operation by calculating the normality information again from the distribution of the inference result at the normal time. Also in a case where determination is made using a plurality of learning models for each frequency bin, the normality/abnormality can be compared between the frequency bins.

### Description of Radio Wave Abnormality Detection System According to Example Embodiment

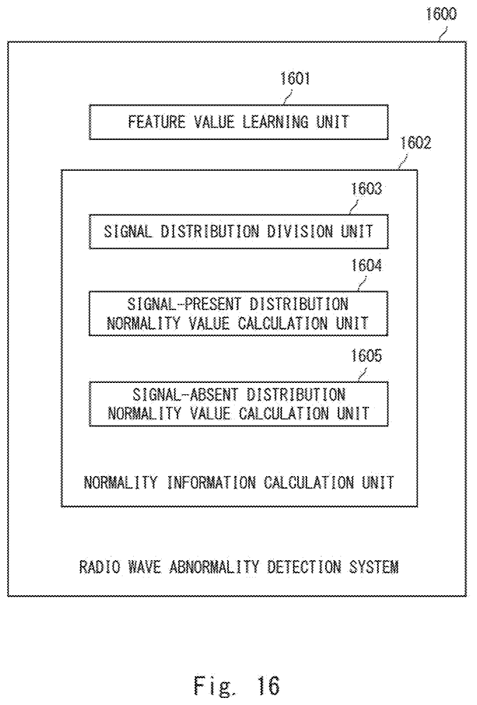

FIG. 16 is a block diagram illustrating a fourth configuration of the radio wave abnormality detection system according to the present disclosure. A radio wave abnormality detection system according to the example embodiment will be described with reference to FIG. 16.

As illustrated in FIG. 16, a radio wave abnormality detection system 1600 according to the example embodiment includes a feature value learning unit 1601 and a normality information calculation unit 1602. The normality information calculation unit 1602 includes a signal distribution division unit 1603, a signal-present distribution normality value calculation unit 1604, and a signal-absent distribution normality value setting unit 1605.

The feature value learning unit 1601 extracts and learns one or more feature values. The feature value learning unit 1601 is relevant to, for example, the feature value learning unit 503, the first feature value learning unit 1303, the second feature value learning unit 1305, the third feature value learning unit 1307, the learning model learning unit 1504, and the like.

The normality information calculation unit 1602 calculates normality information based on the information of the feature value distribution of the learning result. The normality information calculation unit 1602 is relevant to, for example, the normality information calculation unit 504, the first normality information calculation unit 1304, the second normality information calculation unit 1306, the third normality information calculation unit 1308, the normality information calculation unit 1508, and the like.

The signal distribution division unit 1603 divides the distribution of the signal-present portion and the distribution of the signal-absent portion. The signal distribution division unit 1603 is relevant to the signal presence/absence division unit 505, the signal presence/absence division unit 1507, and the like.

The signal-present distribution normality value calculation unit 1604 calculates a normality value of the distribution of the signal-present portion. The signal-present distribution normality value calculation unit 1604 is relevant to the signal-present distribution normality value calculation unit 507.

The signal-absent distribution normality value setting unit 1605 sets the normality value of the distribution of the signal-absent portion. The signal-absent distribution normality value setting unit 1605 is relevant to the signal-absent distribution normality value setting unit 506.

With the above configuration, there is provided a radio wave abnormality detection system that also calculates an index relevant to the normality at the time of learning, and performs normality/abnormality determination and visualization using the index relevant to the normality at the time of operation that is at the time of inference.

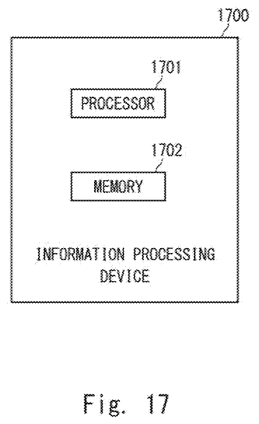

The radio wave abnormality detection method is processed by executing a program in the information processing device. FIG. 17 is a block diagram illustrating a configuration of an information processing device according to the present disclosure. An information processing device 1700 includes a processor 1701 that executes a program and performs processing, and a memory 1702 that stores the program. The information processing device 1700 may include one device or a plurality of devices. The information processing device 1700 may be a cloud server that processes some or all of the functions in a distributed manner.

A part or all of the processing in the radio wave abnormality detection system 500, the learning unit 1302 of the radio wave abnormality detection system, the determination unit 1402 of the radio wave abnormality detection system, the radio wave abnormality detection system 1500, the radio wave abnormality detection system 1600, and the information processing device 1700 described above can be implemented as a computer program. Such a program can be stored and supplied to a computer by using various types of non-transitory computer-readable media. The non-transitory computer-readable media include various types of tangible recording media. Examples of the non-transitory computer-readable media include a magnetic recording medium (e.g., a flexible disk, a magnetic tape, or a hard disk drive), a magneto-optical recording medium (for example, a magneto-optical disc), a Compact Disc Read Only Memory (CD-ROM), a CD-R, a CD-R/W, and a semiconductor memory (e.g., a mask ROM, a Programmable ROM (PROM), an Erasable PROM (EPROM), a flash ROM, or a Random Access Memory (RAM)). The program may be supplied to the computer by using various types of transitory computer-readable media. Examples of the transitory computer-readable medium include electric signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the example embodiments described above may also be described as, but are not limited to, the following Supplementary Notes.

### Supplementary Note 1

A radio wave abnormality detection system including:
a learning unit that learns a radio wave environment in a normal state, the learning unit including:
a feature value learning unit that extracts and learns one or more feature values; and
a normality information calculation unit that calculates normality information based on information of a feature value distribution of a learning result, the normality information calculation unit including a signal distribution division unit that divides a distribution of a signal-present portion and a distribution of a signal-absent portion, a signal-present distribution normality value calculation unit that calculates a normality value of the distribution of the signal-present portion, and a signal-absent distribution normality value setting unit that sets the normality value of the distribution of the signal-absent portion.

### Supplementary Note 2

The radio wave abnormality detection system according to Supplementary Note 1, in which the signal-present distribution normality value calculation unit includes: a signal distribution estimation unit that divides the distribution of the signal-present portion into one or a plurality of distributions and estimates a precondition distribution for each of the divided distributions; and a normality value calculation unit that calculates a normality value for each of the divided distributions based on the precondition distribution and a value of an acquired distribution.

### Supplementary Note 3

The radio wave abnormality detection system according to Supplementary Note 1 or 2, including a determination unit including: a feature value extraction unit configured to extract one or more feature values; a normality information reference unit configured to acquire a normality value with reference to normality information based on an extraction value of the feature value; and a normality/abnormality determination unit configured to determine normality or abnormality.

### Supplementary Note 4

The radio wave abnormality detection system according to Supplementary Note 3, including a visualization unit that visualizes a normality and a determination result by using information of the normality value and information of the determination result output from the determination unit.

### Supplementary Note 5

The radio wave abnormality detection system according to Supplementary Note 4, in which the visualization unit switches and displays an extraction result of the feature value and the normality information, and can select whether a normality/abnormality determination result is superimposed and displayed.

### Supplementary Note 6

The radio wave abnormality detection system according to Supplementary Note 1, in which the feature value is any of signal power, signal duration, signal bandwidth, signal duration bandwidth, normality/abnormality, or similarity.

### Supplementary Note 7

The radio wave abnormality detection system according to Supplementary Note 1, in which the learning unit includes a learning model inference unit that acquires a distribution of inference results at a normal time using signal data in the normal state. (Supplementary Note 8)

The radio wave abnormality detection system according to Supplementary Note 1 or 2, in which the normality information calculation unit calculates a normality value of the distribution of the signal-present portion assuming that the distribution of the signal-present portion is one Gaussian distribution or normal distribution.

### Supplementary Note 9

A radio wave abnormality detection method including:
extracting and learning one or more feature values;
dividing a distribution of a signal-present portion and a distribution of a signal-absent portion, calculating a normality value of the distribution of the signal-present portion, and setting the normality value of the distribution of the signal-absent portion so as to calculate normality information based on information of a feature value distribution of a learning result; and
learning a radio wave environment in a normal state.

### Supplementary Note 10

A program for causing an information processing device to execute:
extracting and learning one or more feature values;
dividing a distribution of a signal-present portion and a distribution of a signal-absent portion, calculating a normality value of the distribution of the signal-present portion, and setting the normality value of the distribution of the signal-absent portion so as to calculate normality information based on information of a feature value distribution of a learning result; and
learning a radio wave environment in a normal state.

### Supplementary Note 11

A radio wave abnormality detection system including a visualization unit that receives normality information and a normality/abnormality determination result of a surrounding radio wave environment, and visualizes the normality information and the normality/abnormality determination result with which a signal-present portion and a signal-absent portion can be distinguished from an input value.

Some or all of the elements (e.g., configurations and functions) described in Supplementary Notes 2 to 8 dependent on Supplementary Note 1 {e.g. device} can also be dependent on Supplementary Note 9 {e.g. method} and Supplementary note 10 {e.g. program} by the dependency relationship similar to those of Supplementary Notes 2 to 8. Some or all of the elements described in any Supplementary Note may be applied to various types of hardware, software, recording means for recording software, systems, and methods.

What is claimed is:

1. A radio wave abnormality detection system comprising:
a memory configured to store instructions; and
a processor configured to execute the instructions:
extract and learn one or more feature values;
divide a distribution of a signal-present portion and a distribution of a signal-absent portion, calculate a normality value of the distribution of the signal-present portion, set the normality value of the distribution of the signal-absent portion, and calculate normality information based on information of a feature value distribution of a learning result; and
learn a radio wave environment in a normal state.

2. The radio wave abnormality detection system according to claim 1, wherein the calculating of the normality value of the signal-present distribution includes: dividing the distribution of the signal-present portion into one or a plurality of distributions and estimating a precondition distribution for each of the divided distributions; and calculating a normality value for each of the divided distributions based on the precondition distribution and a value of an acquired distribution.

3. The radio wave abnormality detection system according to claim 1, wherein the processor is configured to execute an instruction to extract one or more feature values, acquire a normality value with reference to normality information based on an extraction value of the feature value, and determine normality or abnormality.

4. The radio wave abnormality detection system according to claim 3, wherein the processor is configured to execute an instruction to visualize a normality and a determination result by using information of the normality value and information of the determination result output from the determination.

5. The radio wave abnormality detection system according to claim 4, wherein in the visualizing, an extraction result of the feature value and the normality information are switched and displayed, and whether a normality/abnormality determination result is superimposed and displayed can be selected.

6. The radio wave abnormality detection system according to claim 1, wherein the feature value is any of signal power, signal duration, signal bandwidth, signal duration bandwidth, normality/abnormality, or similarity.

7. The radio wave abnormality detection system according to claim 1, wherein the learning includes acquiring a distribution of inference results at a normal time using signal data in the normal state.

8. The radio wave abnormality detection system according to claim 1, wherein the calculating of the normality information includes calculating a normality value of the distribution of the signal-present portion assuming that the distribution of the signal-present portion is one Gaussian distribution or normal distribution.

9. A radio wave abnormality detection method comprising:
extracting and learning one or more feature values;
dividing a distribution of a signal-present portion and a distribution of a signal-absent portion, calculating a normality value of the distribution of the signal-present portion, and setting the normality value of the distribution of the signal-absent portion so as to calculate normality information based on information of a feature value distribution of a learning result; and
learning a radio wave environment in a normal state.

10. The radio wave abnormality detection method according to claim 9, wherein the calculating of the normality value of the signal-present distribution includes: dividing the distribution of the signal-present portion into one or a plurality of distributions and estimating a precondition distribution for each of the divided distributions; and calculating a normality value for each of the divided distributions based on the precondition distribution and a value of an acquired distribution.

11. The radio wave abnormality detection method according to claim 9, further comprising:
extracting one or more feature values; acquiring a normality value with reference to normality information based on an extraction value of the feature value; and determining normality or abnormality.

12. The radio wave abnormality detection method according to claim 11, further comprising visualizing a normality and a determination result by using information of the normality value and information of the determination result output from the determining.

13. The radio wave abnormality detection method according to claim 12, wherein in the visualizing, an extraction result of the feature value and the normality information are switched and displayed, and whether a normality/abnormality determination result is superimposed and displayed is visualized to be selected.

14. The radio wave abnormality detection method according to claim 9, wherein the feature value is any of signal power, signal duration, signal bandwidth, signal duration bandwidth, normality/abnormality, or similarity.

15. The radio wave abnormality detection method according to claim 9, wherein the learning includes acquiring a distribution of inference results at a normal time using signal data in the normal state.

16. The radio wave abnormality detection method according to claim 9, wherein the calculating of the normality information includes calculating a normality value of the distribution of the signal-present portion assuming that the distribution of the signal-present portion is one Gaussian distribution or normal distribution.

17. A non-transitory computer readable medium storing a program for causing an information processing device to execute:
extracting and learning one or more feature values;
dividing a distribution of a signal-present portion and a distribution of a signal-absent portion, calculating a normality value of the distribution of the signal-present portion, and setting the normality value of the distribution of the signal-absent portion so as to calculate normality information based on information of a feature value distribution of a learning result; and
learning a radio wave environment in a normal state.

18. The non-transitory computer readable medium according to claim 17, wherein the calculating of the normality value of the signal-present distribution includes: dividing the distribution of the signal-present portion into one or a plurality of distributions and estimating a precondition distribution for each of the divided distributions; and calculating a normality value for each of the divided distributions based on the precondition distribution and a value of an acquired distribution.

19. The non-transitory computer readable medium according to claim 17, further causing the information processing device to execute: extracting one or more feature values; acquiring a normality value with reference to normality information based on an extraction value of the feature value; and determining normality or abnormality.

20. The non-transitory computer readable medium according to claim 19, further causing the information processing device to execute visualizing a normality and a determination result by using information of the normality value and information of the determination result output from the determining.
